(19) United States
(12) Patent Application Publication
(10) Pub. No.: US 2010/0207746 A1
(43) Pub. Date: Aug. 19, 2010

(54) DRIVE SYSTEM OF VIBRATION MOUSE

(76) Inventors: Koo-Young Song, Seoul (KR); Man-Hyo Kim, Daegu (KR)

Correspondence Address: IPLA P.A., 3550 WILSHIRE BLVD., 17TH FLOOR, LOS ANGELES, CA, 90010, US

(21) Appl. No.: 12/679,898

(22) PCT Filed: Nov. 16, 2007
(86) PCT No.: PCT/KR07/05785

§ 371 Date: Mar. 24, 2010

(30) Foreign Application Priority Data
Oct. 12, 2007 (KR) 10-2007-0102856

(51) Int. Cl. G08B 6/00; G06F 3/033

(52) U.S. Cl. 340/407.2; 345/163

(57) ABSTRACT

The present invention relates to an apparatus for driving a vibration mouse, which is capable of accurately controlling vibration magnitude, vibration time, etc., in such a way as to match a sound effect when driving the vibration mouse and also making the wiring simplified. According to the present invention, a vibration pattern, which is most suitable for an actual sound effect of a game or an application, is produced using a program for allowing an audio signal to become a vibration pattern Windows file. The vibration pattern file is output from the game or the application together with the sound effect. Accordingly, a vibration motor can be controlled according to a vibration pattern that matches an actual acoustic effect.

### TECHNICAL FIELD

The present invention relates generally to an apparatus for driving a vibration mouse, and more particularly, to an apparatus for driving a vibration mouse, which is capable of accurately controlling vibration magnitude, vibration time, etc., in such a way as to match a sound effect when driving the vibration mouse and also making the wiring simplified.

### BACKGROUND ART

Along with the development of information processing technology, users who use game machines or various portable devices request these devices to provide more realistic interactions. Accordingly, there is a growing interest in a method for providing a hardware environment in which tactile information as well as existing visual and auditory information can be delivered more realistically.

In line with this demand, there has been proposed and is recently used a vibration mouse which is configured to further have a vibration motor installed in an existing mouse used in various game machines or computer devices and to vibrate according to the contents of a program when the program is used.

Such a conventional vibration mouse generally adopts a method of receiving a signal from a speaker and driving the vibration motor in response to the received signal. As an example of the vibration mouse, there has been proposed Korean Utility Model Registration No. 319960 entitled Mouse device having voice output means, which is configured to perform a combined mouse and speaker function. In this vibration mouse, an audio signal cable, which is configured to be connected to an output terminal of the sound card of a computer to receive audio signals, is further connected to a USB cable as a mouse signal cable. Accordingly, there is a problem in that the wiring of the mouse device is more complicated.

Further, in mouse devices using this speaker signals, a vibration motor is driven in response to all sound sources generated from the computer. Thus, the vibration motor is driven in response to noises or other unnecessary sound sources besides sound effects of vibration. Accordingly, there is a problem in that a feeling of vibration according to sound effects of actual games or applications is weak and a completely different feeling is delivered.

Meanwhile, power supply voltages are indispensable in electrical and electronic control systems. This is because the power supply voltages are operating voltage sources for driving respective parts or circuit elements of pertinent electrical or electronic products. The operating voltages of electrical and electronic products are within a wide range such as 1.4V, 1.8V, 3.3V, 10V, 24V, and the like, and the products have their inherent operating voltage ranges. Typically, only when the operating voltages are applied to corresponding electrical and electronic products within a preset voltage range, respective loads, that is, circuits and component elements are driven stably.

Meanwhile, it is required to selectively supply the operating voltage to the loads of electrical or electronic products, and boost or drop the operating voltage. In some loads, a driving voltage that varies over time needs to be supplied.

Therefore, if variable voltage sources including constant voltage sources can be supplied to electrical and electronic control systems, it may be widely utilized and applied in the electrical and electronic control systems. Accordingly, there is a need for a device for supplying a controllable voltage source and application devices using the same. In line with this need, the present applicant has proposed a Korean Patent Registration No. 10-0757242, which is related to a technology for supplying a variable voltage source. The present invention has been invented according to the need for the development of a vibration mouse, which enables a user to feel a realistic tactile sensation using the variable voltage source proposed in the above registered patent by the present applicant.

### DISCLOSURE OF INVENTION

### Technical Problem

Accordingly, the present invention has been made in view of the above problems occurring in the prior art, and an object of the present invention is to provide an apparatus for driving a vibration mouse, which is capable of delivering a realistic tactile sensation using a variable voltage source and controlling illuminance according to the contents of a program when the program is used.

### Technical Solution

To achieve the above object, an apparatus for driving a vibration mouse according to the present invention includes a computer, comprising input means for inputting a variety of operation commands, such as a keyboard and a mouse, a CPU for controlling various operations of the computer, a memory for storing various data therein, a pattern-writing program module for writing a vibration pattern Windows file based on an audio signal in response to a control command of the CPU and storing the written vibration pattern Windows file in the memory, a game or application execution module executed by the CPU, when commands for executing games or various applications are input through the input means, and configured to fetch the vibration pattern Windows file from the memory as a function in synchronization with a sound effect, a DLL module for receiving a file including the vibration pattern Windows file output from the game or application execution module, and a human interface drive module of the Windows, for receiving a vibration mouse control signal from the DLL module and outputting the received vibration mouse control signal; and a vibration mouse, comprising a CPU for receiving a signal output from the computer, analyzing contents (strength of vibration, vibration time) of a vibration pattern, and generating a PWM signal corresponding to the vibration pattern, and a variable voltage source circuit for driving a vibration motor M in response to a control signal of the CPU.

Meanwhile, the vibration mouse further comprises light-emitting diodes. The variable voltage source circuit drives both the vibration motor and the light-emitting diodes according to the control signal output from the CPU of the vibration mouse.

The variable voltage source circuit includes a transistor including an input terminal coupled to an input voltage and an output terminal from which an output voltage is output, and an OP Amp for comparing voltage levels of two input signals and controlling the transistor according to the comparison result. The variable voltage source circuit is configured such that control input voltages corresponding to control signals, which can be changed over time, are applied to a feedback circuit for selectively changing a feedback factor of voltage, which is fed back from the output terminal of the transistor and then applied to one input terminal of the OP Amp, and the other input terminal of the OP Amp.

### Advantageous Effects

According to the present invention, a vibration pattern, which is most suitable for an actual sound effect of a game or an application, is produced using a program for making an audio signal a vibration pattern Windows file. The vibration pattern file is output from the game or the application together with the sound effect. Accordingly, a vibration motor can be controlled according to a vibration pattern that matches an actual acoustic effect.

Moreover, the vibration pattern can have its strength controlled by a variable voltage source and create a tactile sensation such as vibration in a reverse direction. Accordingly, a user may experience the sense of touch, which is similar to the reality.

Further, a computer and a vibration mouse are connected only by one cable, and control signals of the mouse and the vibration motor are processed at the same time using the HID of the Windows without hindering the basic operation of the mouse. Accordingly, there is an advantage in that the degree of satisfaction in use is improved.

### BRIEF DESCRIPTION OF THE DRAWINGS

Further objects and advantages of the invention can be more fully understood from the following detailed description taken in conjunction with the accompanying drawings in which:

FIG. 1 is a block diagram showing the configuration of a vibration mouse according to the present invention;

FIG. 2 is a block diagram showing the configuration of a variable voltage source circuit according to the present invention;

FIG. 3 is a characteristic curve diagram of a variable voltage source circuit unit of FIG. 2;

FIG. 4 is a block diagram showing an exemplary driving method of a LED of the variable voltage source circuit unit; and

FIGS. 5 and 6 are block diagrams showing an exemplary driving method of a motor of the variable voltage source circuit unit.

### MODE FOR THE INVENTION

The present invention will now be described in detail in connection with specific embodiments with reference to the accompanying drawings.

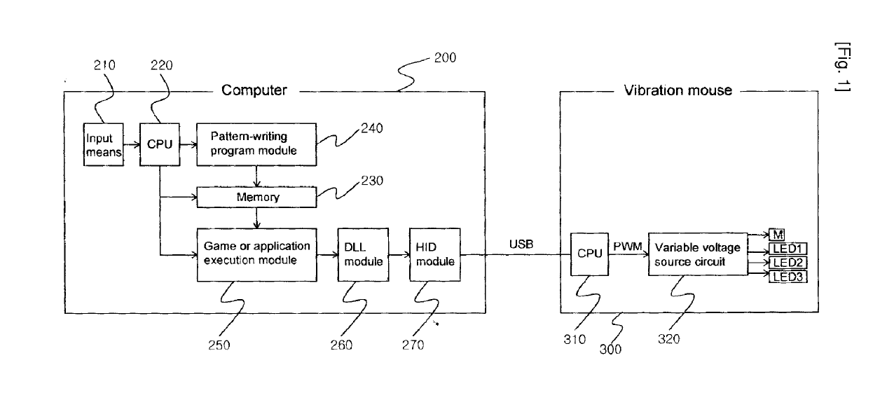

FIG. 1 is a block diagram showing the configuration of a vibration mouse according to the present invention.

An apparatus for driving a vibration mouse according to the present invention includes a computer 200 that outputs a control signal to drive the vibration mouse, and a vibration mouse 300 that operates in response to the control signal of the computer 200.

In the above construction, the computer 200 includes input means 210 for inputting a variety of operation commands, such as a keyboard and a mouse, a CPU 220 for controlling various operations of the computer, a memory 230 for storing various data therein, a pattern-writing program module 240 for writing a vibration pattern Windows file based on an audio signal in response to a control command of the CPU 220 and storing the written vibration pattern Windows file in the memory 230, a game or application execution module 250, which is executed by the CPU 220 when commands for executing games or various applications are input through the input means 210 and is configured to fetch the vibration pattern Windows file from the memory as a function in synchronization with a sound effect, a DLL module 260 for transmitting a file including the vibration pattern Windows file output from the game or application execution module 250, and a Human Interface Drive module (hereinafter referred to as a ‘HID module’) 270 of the Windows, for receiving a vibration mouse control signal from the DLL module 260 and outputting the received vibration mouse control signal.

Further, the vibration mouse 300 includes a CPU 310 for receiving a signal output from the computer 200, analyzing the contents of a vibration pattern (the strength of vibration, the vibration time), and generating a Pulse Width Modulation (PWM) signal corresponding to the vibration pattern, and a variable voltage source circuit 320 for driving a vibration motor M and light-emitting diodes LED1, LED2, and LED3 in response to a control signal of the CPU 310.

The above apparatus for driving a vibration mouse is driven as follows.

1) First, creation of a pattern to be transmitted to a vibration motor constituting a mouse.

A worker produces a primary vibration pattern by analyzing a sound effect, which is generated from a game or application to be executed, by driving the pattern-writing program module for writing a vibration pattern Windows file based on an audio signal in the CPU of the computer using the input means, such as a keyboard or a mouse provided in the computer, produces a secondary vibration pattern or very various forms of vibration patterns higher than the secondary vibration pattern by adding various forms of vibration patterns to the primary vibration pattern, changing the primary vibration pattern or deleting some of the primary vibration pattern, produces a vibration pattern Windows file most optimized for a sound effect that is being generated, records the produced vibration pattern file in the memory of the computer. The pattern produced as described above has a DLL file structure, that is, a unique pattern file structure of the Windows.

2) Fetches of the vibration pattern Windows file from the game or application execution module.

If a command for executing a game or an application is input through the input means, the CPU of the computer fetches the vibration pattern Windows file, which is produced based on a sound effect through the game or application execution module, from the memory simultaneously with the sound effect and transmits the vibration pattern Windows file to the DLL module. According to the present invention, in this process, only one function is fetched.

For example, there is HID_Write (Volume, Time1, Time2). In this configuration, ‘Volume’ denotes the intensity of a vibration motor, and may be set to 0 to 255. ‘Time 1’ denotes a forward vibration time, has the unit of msec, and may be set to 0 to 255. Moreover, ‘Time2’ represents a backward vibration time, has the unit of msec, and may be set to 0 to 255.

3) The transfer of a vibration pattern to the CPU of the vibration mouse by the HID module.

When transferring a vibration pattern signal to the HID module, the DLL module that has received the contents of the vibration pattern transfers the signal to the CPU mounted in the vibration mouse.

In the above construction, the terminology ‘HID’ generally refers to that, when a new device is attached to a computer, necessary drivers are automatically recognized and installed in the computer. The terminology ‘driver’ refers to that, when a new device or unit is connected to a computer, the computer does not recognize what the device or unit is and, therefore, a company that has manufactured the device or unit produces standard rules and regulations on which the device or unit can be recognized by the computer. The vibration mouse of the present invention also complies with the standard rules and regulations. Thus, when the vibration mouse is mounted in a computer, a device drive thereof is automatically recognized by the computer.

4) The output of a PWM signal to the variable voltage source circuit by the CPU of the vibration mouse.

The CPU of the vibration mouse receives the contents (the strength of vibration, vibration time) of a vibration pattern, analyzes the received vibration pattern, generates a PWM signal corresponding to the vibration pattern, and outputs the PWM signal to variable voltage source circuit, that is, a vibration motor driving drive. The CPU of the vibration mouse also generates a PWM signal for adjusting the luminance of three LEDs compatibly with the vibration pattern.

5) The driving of the vibration motor and the LEDs by the variable voltage source circuit.

A vibration motor driving drive and a LED driving drive are adapted to receive the

PWM signal, change the PWM signal to a voltage level, drive the vibration motor using the changed voltage level, and control the illuminance of the LEDs.

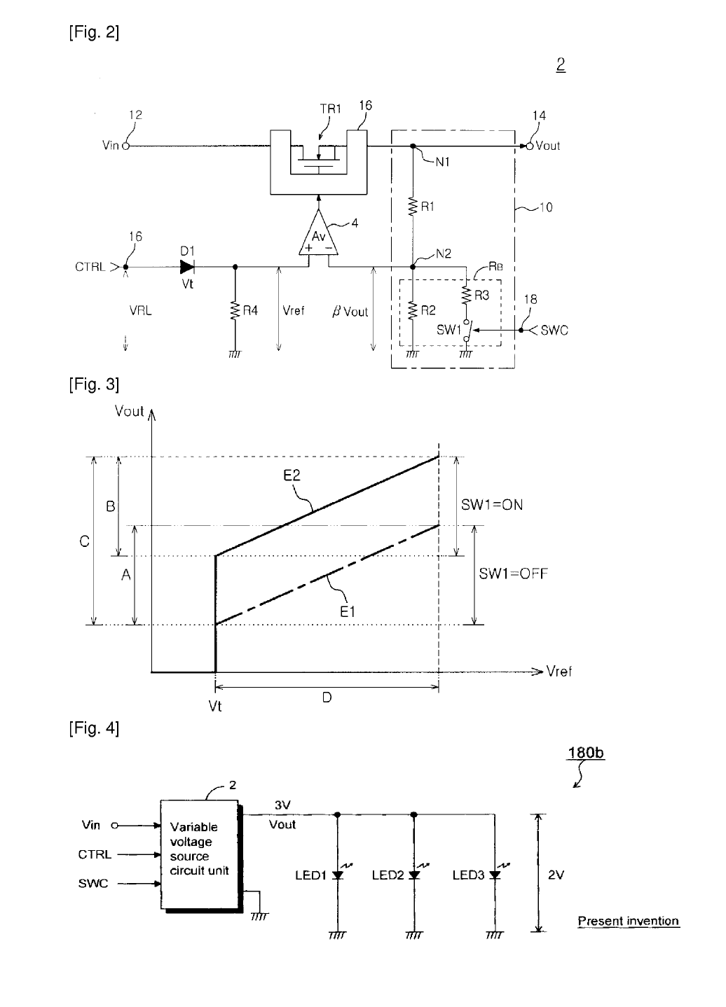

In the above construction, the variable voltage source circuit may use a circuit presented in Korean Patent Registration No. 0757242 described above in [Background Art], and a representative construction thereof is shown in FIG. 2.

A variable voltage source circuit unit 2 includes an N channel MOSFET (hereinafter referred to as a ‘transistor’) TR1, a diode D1, a resistor R4, an OP Amp 4, a feedback circuit 10, and an over-current and over-heat block circuit 6 for blocking over current and over heat of the N channel transistor TR1.

In the above, the transistor TR1 has a drain terminal to which an input voltage (Vin) is applied through an input terminal 12, and a source terminal connected to an output terminal 14 from which an output voltage (Vout) is output, and a gate terminal to which a gate control signal, output from the OP Amp 4 for comparing and amplifying two input signals, is applied.

In FIG. 2, ‘Vref’ denotes voltage applied to a non-inverting input terminal (+) of the OP Amp 4, ‘Av’ denotes a voltage gain of the OP Amp 4, and ‘β’ denotes a feedback factor. The output voltage (Vout) of the variable voltage source circuit unit 2 may be found using the following equation 1.

$$\begin{matrix}MathFigure 1 & \\ Vout = Vref \frac{Av}{1 + Av β} & [ Math . 1 ]\end{matrix}$$

In Equation 1, if a value of the product of the feedback factor 13 and the voltage gain Av of the OP Amp 4, that is, β*Av is sufficiently great to the extent that “1” placed in the denominator of Equation 1, the output voltage (Vout) of the variable voltage source circuit unit 2 can be expressed in ‘Vout=Vref/β’. Accordingly, the output voltage (Vout) may be formed into a constant voltage source using the following method.

That is, it may be performed by making constants both the control input voltage (Vref), applied to the non-inverting input terminal (+) of the OP Amp 4, and the feedback factor β of the output voltage (Vout), which is fed back to the inverting input terminal (−) of the OP Amp 4.

Further, the output voltage (Vout) may be formed into a variable voltage source using the following method. That is, it may be performed by allowing at least one of the control input voltage (Vref) and the feedback factor β to become a variable. In other words, if at least one of the control input voltage (Vref) and the feedback factor β becomes a variable whose value changes consecutively or abruptly over time, the output voltage (Vout) becomes a variable voltage source.

The method of allowing at least one of the control input voltage (Vref) and the feedback factor (3 to become a variable is described in detail below.

First, in order to make a variable the control input voltage (Vref) applied to the non-inverting input terminal (+) of the OP Amp 4, a control signal CTRL applied to a control signal input terminal 16 is implemented to change over time. In the present invention, a PWM signal is used as a source type of the CTRL.

Next, in order to form the feedback factor β as a variable, the feedback circuit 10 as shown in FIG. 2 is configured. The feedback factor β is not implemented to consecutively change in view of its circuit characteristic.

In the feedback circuit 10, one terminal of a resistor R1 is coupled to a node N1 between the source terminal of the N channel transistor TR1 and the output terminal 14, and the other terminal of the resistor R1 is coupled to an inverting input terminal (−) of the OP Amp 4 through a node N2. A resistor R2 having one terminal grounded is coupled to the node N2. One terminal of a resistor R3, which is connected in parallel to the resistor R2, is connected to the resistor R2. A switch SW1 having one terminal grounded is connected to the other terminal of the resistor R3. A switch control signal SWC is applied to the switch SW1. The feedback factor β has two states depending on an on or off state of the switch SW1.

Accordingly, the feedback factor β has two values (first and second feedback factors). As shown in FIG. 3, when the switch SW1 of the variable voltage source circuit unit 2 is turned off, an operating characteristic curve E1 appears, and when the switch SW1 is turned on, an operating characteristic curve E2 appears.

In FIG. 3, ‘D’ indicates a variable voltage input signal area of the control input voltage (Vref). ‘Vt’ is a turn-on voltage of the diode D1, and is a reference voltage that functions to operate or not operate the variable voltage source circuit unit 2. The turn-on voltage (Vt) of the diode D1 also functions to prevent the variable voltage source circuit unit 2 from malfunctioning due to noise or weak power applied to the control terminal 16. Therefore, the output voltage (Vout) of the variable voltage source circuit unit 2 is output only when a voltage level VRL of the control signal CTRL applied to the diode D1 is higher than the diode turn-on voltage (Vt).

An output dynamic range C is decided by an output dynamic range A of the operating characteristic curve E1 and an output dynamic range B of the operating characteristic curve E2. The output dynamic ranges A and B are overlapped with each other at its middle portion. Such overlapping of the output dynamic range A of the operating characteristic curve E1 with the output dynamic range B of the operating characteristic curve E2 is accomplished by controlling a resistance value of the resistor R3, which is connected in series to the switch SW1 of the feedback circuit 10.

Therefore, the output dynamic range C of the output voltage (Vout) almost expands up to about a dynamic range ‘A+B’.

Meanwhile, a signal processing unit, such as a filter or a bias circuit unit, is selectively provided in front of the control signal input terminal 16 of the variable voltage source circuit unit 2 depending on the characteristic of the control signal CTRL applied to the control signal input terminal 16. In the case in which, as in the present invention, the source of the CTRL is a PWM signal, a Low Pass Filter (LPF) for removing integral and high frequency components is provided as the signal processing unit in front of the control signal the input terminal 16.

Next, what the variable voltage source circuit constructed as above drives a LED driving circuit 180b is described below with reference to FIG. 4. An input power (Vin), the control signal CTRL (indispensable), and the switch control signal SWC (optional) are input to the variable voltage source circuit unit 2, an output voltage (Vout) is changed depending on the definition of a user because the control signal CTRL is a PWM signal. Therefore, for example, if an output operating range of the LED ranges from 1.8 to 2.3V under the control of the switch control signal SWC, the output voltage (Vout) of the variable voltage source circuit unit 2 is output variably within the voltage range of 1.8 to 2.3V, and therefore luminance of the LED is changed.

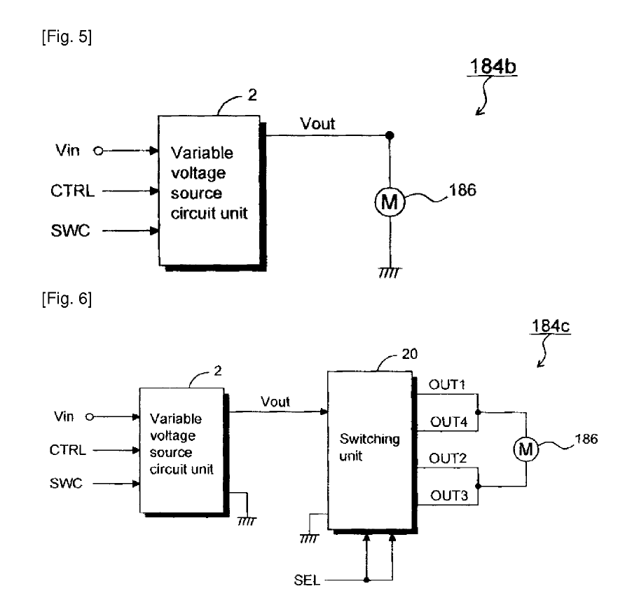

FIGS. 5 and 6 are diagrams showing embodiments of motor driving devices 184b, 184c using the variable voltage source according to an embodiment of the present invention.

In FIG. 5, a variable voltage source circuit unit 2 of a vibration motor device 184b using the variable voltage source of the present invention is configured to output an output voltage (Vout) because the control signal CTRL is a PWM signal. Therefore, for example, if an operating range of a vibration motor 186 is 2 to 3.2V, the output voltage (Vout) of the variable voltage source circuit unit 2 is output variably within a voltage range of 2 to 3.2V, and a rotation speed of the vibration motor 186 thereof is changed in response thereto.

Further, a vibration motor device 184b using the variable voltage source shown in FIG. 6 further includes a full bridge circuit unit using a switching unit 20 in rear of the variable voltage source circuit unit 2 of FIG. 5. Thus, the rotation direction of a vibration motor 186 can be changed by changing the direction of current, applied to the vibration motor 186, depending on the logic state of a select signal SEL. For example, if the select signal SEL is in a logic ‘high’ state, the vibration motor 86 is rotated clockwise, and if the select signal SEL is in a logic low state, the vibration motor 86 is rotated counterclockwise.

In this case, one input terminal of the full bridge circuit unit is coupled to a variable output voltage (Vout) of the variable voltage source circuit unit 2, and the other input terminal of the full bridge circuit unit is grounded.

1. An apparatus for driving a vibration mouse, comprising:
a computer (200), comprising input means (210) for inputting a variety of operation commands, such as a keyboard and a mouse, a CPU (220) for controlling various operations of the computer, a memory (230) for storing various data therein, a pattern-writing program module (240) for writing a vibration pattern Windows file based on an audio signal in response to a control command of the CPU (220) and storing the written vibration pattern Windows file in the memory (230), a game or application execution module (250) executed by the CPU (220), when commands for executing games or various applications are input through the input means (210), and configured to fetch the vibration pattern Windows file from the memory as a function in synchronization with a sound effect, a DLL module (260) for receiving a file including the vibration pattern Windows file output from the game or application execution module (250), and a human interface drive module (270) of the Windows, for receiving a vibration mouse control signal from the DLL module (260) and outputting the received vibration mouse control signal, and a vibration mouse (300) including a CPU (310) for receiving a signal output from the computer (200), analyzing contents (strength of vibration, vibration time) of a vibration pattern, and generating a PWM signal corresponding to the vibration pattern, and a variable voltage source circuit (320) for driving a vibration motor M in response to a control signal of the CPU (310).

2. The apparatus as claimed in claim 1, wherein the vibration mouse (300) further comprises light-emitting diodes (LED1, LED2, and LED3), and the variable voltage source circuit (320) drives both the vibration motor M and the light-emitting diodes (LED1, LED2, and LED3) according to the control signal output from the CPU (10) of the vibration mouse (300).

3. The apparatus as claimed in claim 1, wherein the variable voltage source circuit (320) comprises:
a transistor including an input terminal coupled to an input voltage and an output terminal from which an output voltage is output, and an OP Amp for comparing voltage levels of two input signals and controlling the transistor according to the comparison result, wherein control input voltages corresponding to control signals, which can be changed over time, are applied to a feedback circuit for selectively changing a feedback factor of voltage, which is fed back from the output terminal of the transistor and then applied to one input terminal of the OP Amp, and the other input terminal of the OP Amp.

4. The apparatus as claimed in claim 2, wherein the variable voltage source circuit comprises:
a transistor including an input terminal coupled to an input voltage and an output terminal from which an output voltage is output, and an OP Amp for comparing voltage levels of two input signals and controlling the transistor according to the comparison result, wherein control input voltages corresponding to control signals, which can be changed over time, are applied to a feedback circuit for selectively changing a feedback factor of voltage, which is fed back from the output terminal of the transistor and then applied to one input terminal of the OP Amp, and the other input terminal of the OP Amp.
